(19) United States
(12) Patent Application Publication
(10) Pub. No.: US 2004/0111383 A1
(43) Pub. Date: Jun. 10, 2004

(54) Bulk product cost differential simulator

(75) Inventors: Eric McConnell, North Olmsted, OH (US); Sean Riley, Bay Village, OH (US)

Correspondence Address: BANNER & WITCOFF, 1001 G STREET N W, SUITE 1100, WASHINGTON, DC, 20001, US

(73) Assignee: Cargill, Inc.

(21) Appl. No.: 10/725,583

(22) Filed: Dec. 3, 2003

Related U.S. Application Data
(60) Provisional application No. 60/430,664, filed on Dec. 4, 2002.
(60) Provisional application No. 60/431,183, filed on Dec. 5, 2002.

(51) Int. Cl. G06G 7/00

(52) U.S. Cl. 705/400

(57) ABSTRACT

A computer system and method for calculating and estimating bulk product cost differentials is disclosed herein. Aspects of the invention improve upon modern methods for processing and evaluating bulk product items like salt or animal feed by reducing marketing costs while increasing product visibility. Furthermore, aspects of the invention allow a potential client to manipulate a variety factors and variables to customize a pricing estimate for their specific need. Once the factors have been defined, the estimator may automatically determine cost differentials for a single product or for comparing multiple products. Another aspect of the invention allows a client to seamlessly transition between configuring a cost savings estimate and purchasing the product. The invention may also be implemented in a variety of ways, including on a network like the Internet. An option may also exist that allows clients to input their own variables or factors or to submit customized methods for determining costs.

### CROSS-REFERENCED APPLICATIONS

This application claims priority to provisional U.S. application Ser. No. 60/430,664, filed Dec. 4, 2002, herein incorporated by reference. In addition, this application claims priority to provisional U.S. application Ser. No. 60/431,183, filed Dec. 5, 2002, also herein incorporated by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Aspects of the invention relate generally to a computer processing system and computer-implemented tool for bulk product cost simulator for a graphical user interface. More specifically, aspects of the present invention relate to computer processing system and methods by which cost variables may be manipulated and combined to produce savings estimations and cost and usage comparisons.

### BACKGROUND OF THE INVENTION

In a competitive marketplace, businesses and sales representatives constantly battle to differentiate their product from other similar items and to prove superiority. Such an endeavor typically requires sales representatives and companies to travel from potential client to potential client in an effort to pitch their product and its benefits. Clients, while concerned about the overall quality of the product, also focus on the costs and economic impact of purchasing the product. Thus, sales representatives must not only demonstrate the quality of their item, but must also demonstrate to potential clients the product's economic advantages. With a limited marketing period and substantial travel and advertising costs, companies and sales representatives are often unable to cover the entire market and risks losing profits. Companies may be able to achieve more profit and cover a larger share of the market with a less costly and more distributable marketing solution that presents the benefits and advantages of the product to the customer.

Some of the current marketing tools and strategies include on-site presentations, brochures and samples of the new product. However, the current tools are often costly and/or are not sufficiently customized or each potential customer to thoroughly evaluate the products merits. On-site presentations require representatives from a sales company to travel to the customer's location or place of business and make a presentation adapted to the needs and characteristics of that particular client. While presentations may be customized for each customer, such an approach requires substantial financial overhead that may ultimately hinder the selling company's ability to reach a significant portion of the market. Brochures are also popular marketing tools and may be mass-produced at reasonable costs. However, brochures do not offer customized data and information and do not allow customer's to manipulate individual factors or pose possible scenarios. Samples, like brochures, may be widely distributed but the cost may be a more significant concern since the company is essentially giving away the product. In addition, samples may not provide statistical data or cost estimations that may be relevant to a company's decision to purchase certain products.

Additionally, presentations or marketing pitches given by salesmen may negatively influence a company's opinion of the product. Over the years salesmen have acquired a reputation as being notoriously shrewd and deceptive. As such, a salesman's recommendation of a specific product may actually evoke questions of veracity and feelings of doubt from the customer rather than convince or impress them. Potential clients may feel much more secure and satisfied with a new choice of product if they were able to manipulate the variables and explore the product thoroughly themselves.

Therefore, with the high costs for making individualized presentations and the impersonality and generality of brochures or pamphlets, companies with new products hoping to enter a particular industry would find marketing and selling difficult. For example, a salt company hoping to market and sell a new type of chemical for deicing roads may incur significant expenditures creating presentations customized to each potential customer and traveling on-site to make a pitch. The high overhead for individualized presentations may also hinder the salt company from engaging a larger sector of the market. On the other hand, the salt company may hope to save on marketing costs and use a brochures/pamphlets scheme instead. In such a scenario, while the company may save money, the brochures and pamphlets would lack the personal tailoring some companies may value. Thus, a method is needed to merge the tailoring of product comparisons according to a set of specific variables with the low cost and distributable characteristics of pamphlets or brochures.

### BRIEF SUMMARY

Aspects of the present invention relate generally to a computer processing system and computer-implemented tool for bulk product cost simulation for a graphical user interface or the computer environment.

In one aspect, a computer system includes a processor; and a memory for storing computer readable instructions that, when executed by the processor, cause the computer to perform a step of receiving a set of data corresponding to a set of predetermined variables; determining a total cost estimate of one or more products using the set of data corresponding to the set of predetermined variables; determining a difference in cost and generating a cost differential report according to the estimated total cost for each product; and displaying the cost and savings calculations.

Aspects of the present invention relate to a tool for showing customers the benefits of switching from regular bulk deicing salt to a treated salt. By taking cost information pertaining to their winter maintenance programs and entering it into the tool, a customer may see the difference in overall cost between the two products.

One aspect of the present invention provides simulation of the costs associated with marketing a product while providing potential customers the freedom to examine and manipulate a number of processing variables in estimating costs and savings. The present invention may be used in a number of scenarios including situations in which two products with a quantifiable difference are compared for cost effectiveness.

One aspect of the present invention provides a graphical user interface for a computer system. The graphical user interface includes a first display portion configured to accept user input relating to a material product and a corresponding monetary value. A second display portion is configured to accept user input relating to other cost data associated with the material product; and a third display portion is configured to display graphical objects associated with generating a cost differential report associated with the material product and another predetermined product.

These and other objects and features of the invention will be apparent upon consideration of the following detailed description thereof, presented in connection with the following drawings in which like reference numerals identify the elements throughout.

### BRIEF DESCRIPTION OF THE DRAWINGS

FIG. 1 is a functional block diagram of a general purpose computer environment that may be used to implement one or more aspects of the present invention.

FIG. 2 is a schematic representation of a user interface environment according to one embodiment of the invention.

FIG. 3 is a schematic representation of a costs and savings report display environment according to one or more aspects of the present invention.

FIG. 4 is a schematic representation of a bulk break-even cost module implemented in the general purpose computing environment of FIG. 1 according to one or more aspects of the present invention.

FIG. 5 is a functional block process diagram of a computer implemented method of calculating product cost differentials according to one or more aspects of the present invention which can implement in the computer environment shown in FIG. 1.

FIG. 6 illustrates a storage structure according to one or more aspects of the present invention.

### DETAILED DESCRIPTION

The following description is divided into sub-sections to assist the reader. The sub-sections include overview; general purpose computing environment; user interface environment; cost/saving environment; break-even module; and process flow.

General Purpose Computer Environment

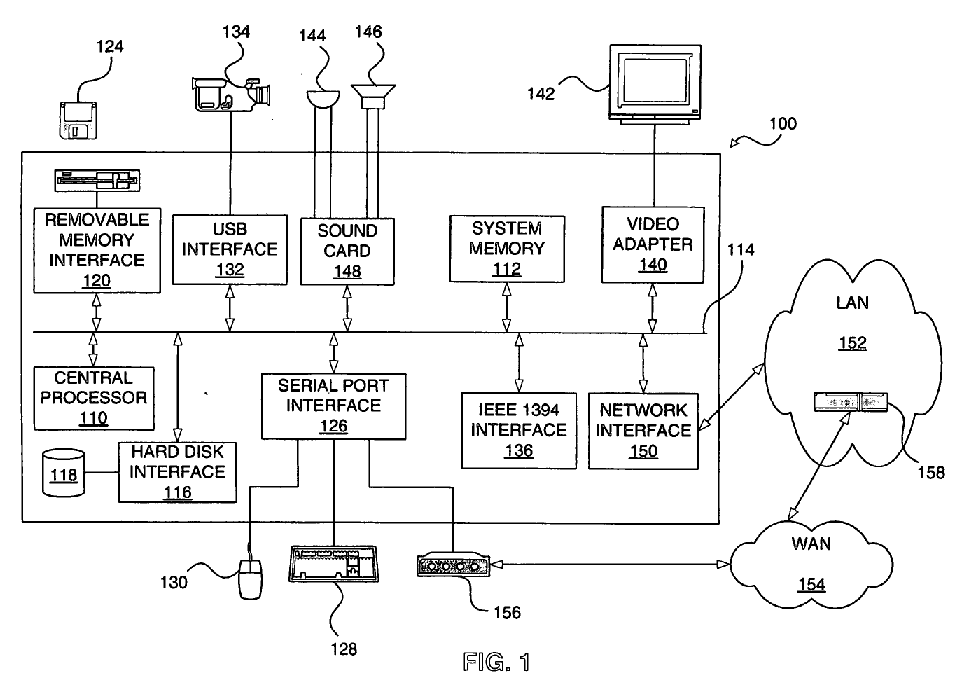

Various aspects of the present invention may be implemented in the context of data structure, program modules, program and computer instructions executed in a computer implemented environment. Thus, it is helpful to briefly discuss a general purpose computing environment. Accordingly, one or more aspects of the invention may be embodied in one or more computer systems, such as is illustrated in FIG. 1.

In FIG. 1, computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may be configured to operate with particular manufacturer interfaces such as FireWire developed by Apple Computer and i.Link developed by Sony. Input devices may also be coupled to system bus 114 through a parallel port, a game port, a PCI board or any other interface used to couple an input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 146. A sound card 148 may be used to couple microphone 144 and speaker 146 to system bus 114. One skilled in the art will appreciate that the device connections shown in FIG. I are for illustration purposes only and that several of the peripheral devices could be coupled to system bus 114 via alternative interfaces. For example, video camera 134 could be connected to IEEE

1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, may also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, libraries, etc. that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants, mobile telephones and the like. Furthermore, the invention may also be practiced in distributed computing environments where tasks are performed by remote processing devices that are linked through a wireless or wired communications network. In a distributed computing environment, program modules may be located in both local and remote memory storage devices.

Various inventive methods may be embodied as computer readable instructions stored on a computer readable medium such as a floppy disk, CD-ROM, removable storage device, hard disk, system memory, embedded memory or other data storage medium. The computer readable medium stores computer executable components, or software modules. More or fewer software modules may alternatively be used. Each component may be an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings of the present invention.

User Interface Environment

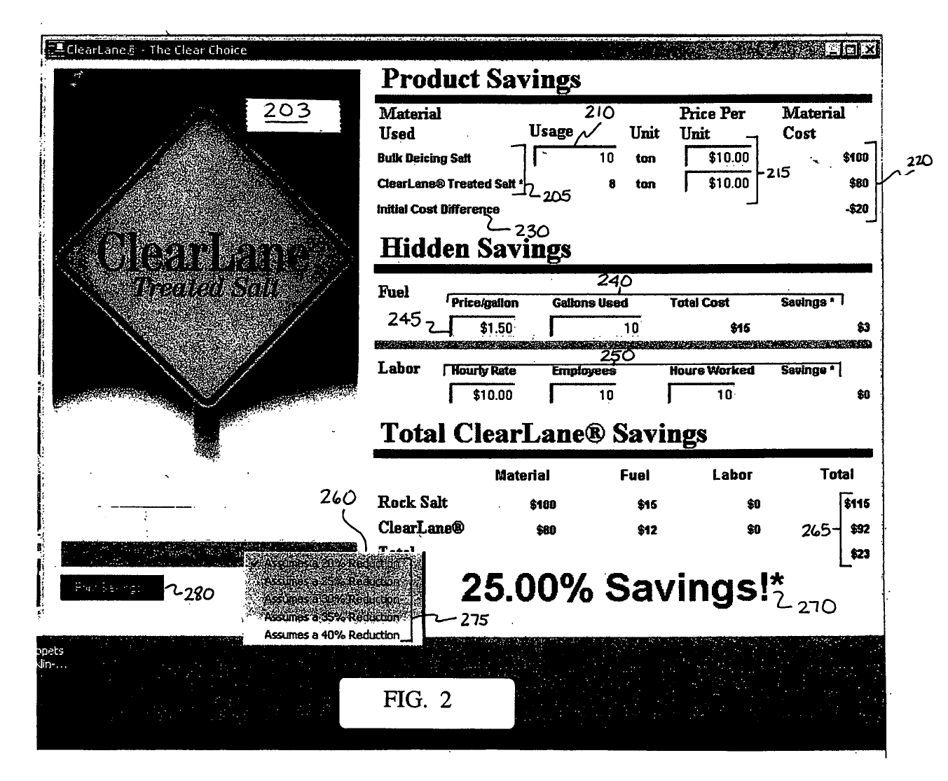

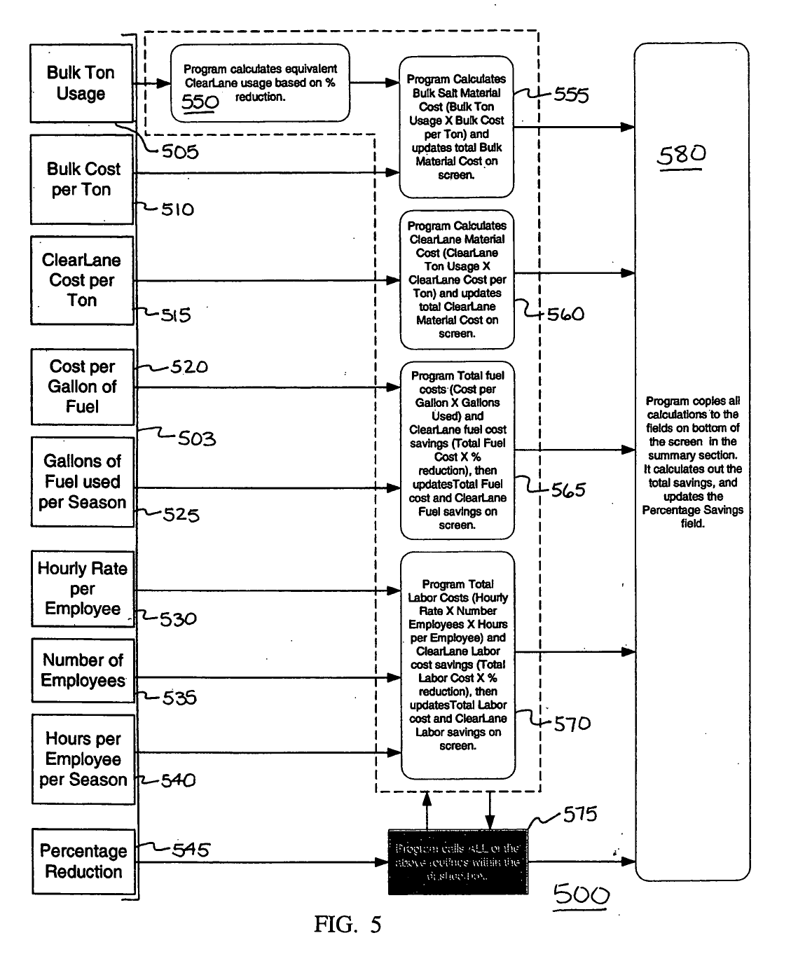

FIG. 2 illustrates a user interface environment according to one or more aspects of the present invention. A user interface 200 may be contained within one portion of a display or may comprise several portions or components (not shown) for a graphical user interface. Depending on various factors such as operating system or graphical capabilities, the user interface 200 may also be text-based, menu-driven, or in some other form operable with a computer or computer network system. The user interface 200 may comprise several components including data entry portions 210 and 215, savings and costs estimate areas 220 and 270, menu portions 260, print 280 and clear (not shown) options, and advertisements or logos 203 corresponding to computer process modules and data structures illustrated in FIG. 5. The user interface 200 may be embodied in several formats and the components may be arranged in numerous ways. For example, each component may be contained within its own window.

Using the interface 200, companies or users may enter data or other variables into the entry areas 210 and 215 to customize the estimate. Some examples of entry areas may include usage amount 210, price per unit 215 and price per gallon 245. Factors and variables corresponding to process modules may also be manipulated and changed through non-entry field type interfaces. For example, if a powder salt is more concentrated than a solid rock salt, less may be required to accomplish the same task. Therefore, a predetermined portion of the interface 260 may be implemented to provide users a list of percentage reductions in usage amount 275. Other predetermined portions of the interface 260 may also be used for other purposes such as giving users a list of products that may be compared with the advertised product.

The interface 200 may be linked to a method for including additional process modules according to a potential customer's concerns or desires. Additional variables 240 and 250 may include travel costs, maintenance fees and storage expenses. Other options that may be included are a print savings option 280 and an option to clear all fields on the screen (not shown). For example, if a potential client wishes to view costs and savings under an entirely different scenario, the client may press the clear button to erase all previously entered data. The user interface 200 may also include several display portions 270 and 265 to show the potential customer or user savings or cost estimates as process modules 240 and 250 are entered, changed or eliminated. For example, after values and data have been entered, the user may select a process option and a percentage savings 270 would be displayed on the bottom portion of the interface 200. In another aspect, the user interface may include self-populating price field. Based on a list of questions such as tons requested for purchase, location, method of delivery, etc., a price per ton of bulk material may be populated into the tool and may be generated in a quote letter when the customer prints the savings sheet.

In one example, a customer may utilize the computer implemented cost estimation tool to manage its winter maintenance programs. The customer may enter several pieces of information corresponding to the various data structures and process modules 503 of the computer implemented tool. Some of these variables include deicing salt usage, deicing salt cost, fuel costs per gallon 245, gallons of fuel used, average salary per employee, number of employees per season, and hours worked per season. A total dollar amount may then be calculated for each category of information as is described in process blocks 555, 560, 565 and 570. For example, a total salt cost 220 may be estimated by multiplying the deicing salt usage by the deicing salt cost. Likewise, the total employee expenditure may be determined by multiplying the average salary with the number of employees with the hours worked per season. A customer may also set a usage reduction amount 275 according to the amount of the new salt product necessary to complete the same task, as is described in process module 550. For example, a customer may set a 20% reduction if four tons of the new salt product completes the same task as five tons of the old salt. Similarly, the fuel costs and employees cost may also be reduced by the same percentage. Therefore, 1000 tons of the old salt product would translate to 800 tons of the new salt. After entering the new salt product price, corresponding total dollar values may be calculated for the new salt product. The resulting calculations and values for the new product may be posted side-by-side with the estimations for the current product. The calculation tool may also automatically recalculate all values and amounts upon the selection of a new percentage reduction value 275. Upon completion of estimation and calculation tasks, the customer may print a product differential worksheet or report. In addition, if the customer selects the print savings option 280, a prompt may appear for the customer to indicate the customer's state.

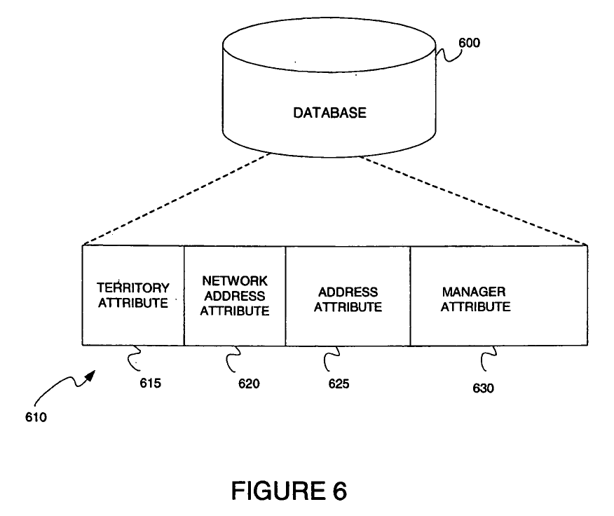

FIG. 6 illustrates a storage structure according to one or more aspects of the present invention. The computer readable storage facility 600 may be a remote database or a file separate from the computer system or method. For ease of explanation, the facility will be called a database. The database 600 may comprise several data types or attribute records. For example, the database 600 may store a list 610 of territory manager attribute records 610. Each attribute record may include a name of territory manager who may be contacted for further information about purchasing a product. Since territory managers are delegated to particular areas of a country or the world, each territory manager attribute record 610 may contain information indicating the Territory attribute 615, containing a state or region for which the manager is responsible. Other information may also be included in the database and/or entries, including a network address attributes 620, such as a phone number, an address attribute 625, and a manager attribute 630. The database 600 may also organize the data in a variety of ways. For example, the territory manager entries may be stored alphabetically, by phone number, or by region.

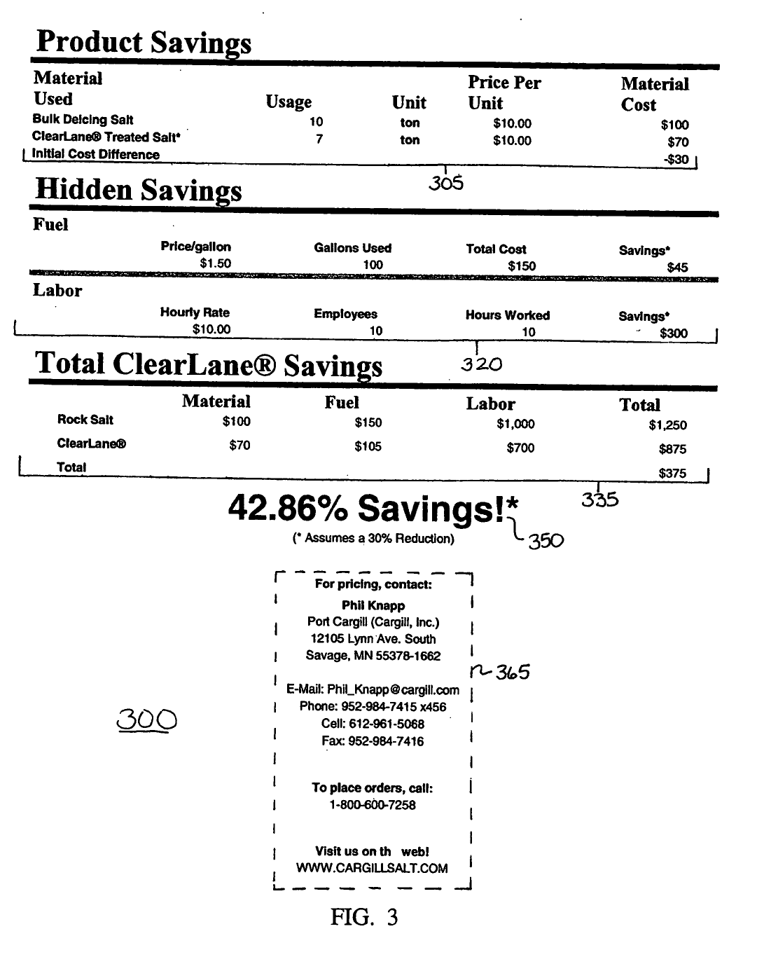

FIG. 3 illustrates a cost and savings report summary according to one or more aspects of the present invention. The cost and savings report 300 may comprise several informational categories such as product savings 305, hidden savings 320 and total product savings 335, as well as total percentage savings 350 and pricing contact information 365. Under each category 305, 320 and 335, a list of factors and their corresponding price, cost and savings may be included. The summary report 300 may also display the percentage reduction assumption 355 and the overall savings 350 after accounting for all processing considerations included in the estimation. In addition to the savings estimate, the report may also comprise contact information 365 for potential customers to obtain more specific pricing quotes or to place an order. The summary report may further comprise other data such as payment options or availability. Such information may be important if a customer is relying on the price and estimate for the successful operation of his or her business.

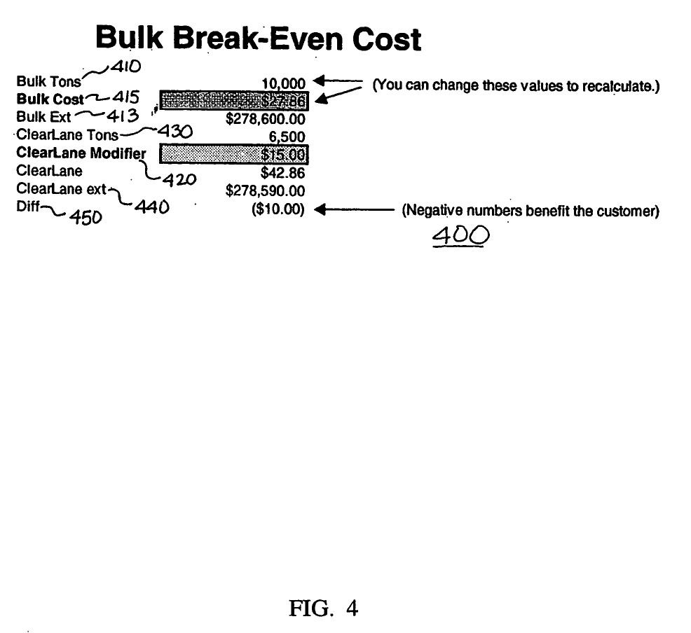

FIG. 4 illustrates a bulk break-even cost tool according to one or more aspects of the present invention. The break-even cost tool 400 calculates at what minimum bulk cost the marketed product would be beneficial for the customer. This feature may allow the company or salesman marketing the new product to target a particular segment of the market so that costs are not expended on potential customers who may not benefit from changing their product choice. A company or salesman may manipulate the bulk tons 410, bulk cost 415 and a product cost modifier 420 to tailor profit margins or cost estimations. The bulk tons 410 and bulk cost 415 may be used to calculate the total product cost 413 of a potential customer's current product. The product cost modifier 420 may be used to specify a profit margin for the sale of the new marketed product. The tool may automatically determine the amount of the marketed product 430 that can achieve the same results as the amount 410 of the potential customer's current/old product. Once the old cost 413 and the potential new cost 440 have been calculated, the difference 450 between the two may be calculated to show the potential benefit or detriment to the customer. For example, if the calculated product cost differential for two types of deicers was 42.86%, this would be converted to a dollar value (i.e. $42.86) in the break-even cost method. A customer may then indicate how much he/she would like to charge above the regular bulk deicing cost in the modifier field. If the customer enters $15 in this field, the break-even method will show that deicer consumers paying $27.86 or higher for salt would benefit from the new product. It is recognized that the present invention can be used for a wide range of products. Other products with a quantitative difference may also be compared and entered into the cost estimator tool. For example, companies utilizing granular products like dishwashing powder and laundry detergent may also benefit from a tool that compares and estimates the costs of two or more competing products, while helping to cut costs and increase efficiency.

Further, aspects of the present invention may be used to encourage customers to remain with a current brand of product rather than switch. For instance, one may use a computer system to determine that switching to a less efficient product may be more expensive than remaining with a more efficient product. Also, in some situations, the cost of a more efficient product may be substantially more than the efficiencies gained in switching to it from a less efficient product. For instance, a product may be 2% more efficient in relation to another product yet be twice as expensive. Accordingly, switching to this product may be reflected by a net increase in costs.

FIG. 5 illustrates a functional block diagram of a computer-implemented method of calculating product cost differentials according to one or more aspects of the invention. A set of process modules or factors 503 may be used to estimate the final cost and savings of using the new product versus the old or competing item. One variable that may be included is the bulk ton usage 505, which refers to the usage amount of the existing/old product. Block 550, the method may use the bulk ton usage 505 to calculate an equivalent new product usage amount based on a percentage reduction 545. For example, if 1000 lbs. of a deicing agent is currently used but switching to a new deicing substance with a higher concentration or effectiveness would decrease the amount required to accomplish the same objectives by 25%, a company would only need 750 lbs. of the more concentrated deicer. After determining the new product usage amount, a total bulk material cost may be calculated by multiplying the bulk ton usage 505 with the bulk cost per ton 510 as shown in block 555. Other methods or processes may also be implemented to calculate the total bulk material cost. In block 560, after the new product cost per ton 515 has been entered, a new product total material cost is calculated. Several methods of determining the total material cost may be used. For example, one method may determine the material cost by multiplying the new product usage amount by the new product cost per ton 515.

In addition to material costs, processing variables such as fuel and labor may also be included in the cost estimation process. In blocks 565 and 570, the fuel and labor total costs may be calculated in several ways. Some data that may be used are cost per gallon of fuel 520, gallons of fuel used 525, hourly rate per employee 530, number of employees 535 and/or hours per employee 540. The fuel costs may be determined by multiplying the cost per gallon of fuel 520 with the amount of fuel that is used 525. Similarly, the total labor cost may be determined by multiplying the number of employees 535 with the hourly rate per employee 530 and further multiplying that amount with the hours worked per employee 540. In block 570, a further calculation may be made to determine the reduction in labor given the percentage reduction 545 in new product usage amount. All calculations made and processing considerations entered may then be sent to a central processing module 575 that processes costs and savings according to the variables entered and previous calculations made. One method that may be used to determine the percentage savings is to add all the costs (e.g., material, fuel, labor) of each product (e.g., new versus current/old) to produce the total cost for each product, determine the difference between the total cost of each product and divide the difference by the old product cost. Other relevant values such as percentage reduction in labor and fuel costs as a percentage of total costs may also be estimated. The variables and resulting values may then be sent to the display screen and formatted into a summary report in block 580. The display may be updated either automatically or manually depending on user preference. If the display is updated automatically, every new entry of data or change of data may refresh the report. A manual mode of display may require the user to choose a process or display option to update the savings and cost summary on the screen.

In another embodiment of the invention, the user interface and program method may be implemented through a graphical user interface on a network such as a web page. Such an implementation may further reduce marketing costs and provide additional advantages to the potential customers. By implementing a web-based tool, the marketability of the product would increase significantly since any company or business that has network access may use the product cost differential tool's user interface and explore the advertised product. Furthermore, a distributable medium, like CDs, would no longer be required and would thus reduce costs. This implementation may also be advantageous to the potential customer since the tool may be accessed from any location with network access. For example, if a potential client decides to explore the new product further and would like to show the savings and costs estimates to the CEO of his/her company who is currently off-site, the client need only direct the CEO to the website instead of having to send a copy of the CD or program.

In addition, if a correction or upgrade becomes necessary, the company advertising the new product need only correct or upgrade the local product cost differential tool instead of sending out a new copy per potential client. Clients may also benefit from such a method or program by saving money on purchases. For example, a supplier selling animal feed may charge more during the beginning of the year than at the end of the year. A tool accessible through the network like the Internet would allow price changes to be made without significant effort or expenditure. Therefore, a client may take advantage of a low price by accessing the cost estimation tool periodically for price changes rather than having to contact the company or wait for a new brochure to reach them. Especially in industries where prices are changing on a daily basis, cost estimates would expire before the quotes have even reached a potential client. Another advantage of using a network like the internet to implement a calculation method is the ability to instantaneously receive a quote, email the sales company or place an order without having to switch tasks. For example, the tool may be implemented to lead seamlessly to a product order form or a price quote request form where the client fills in the necessary information to complete a transaction without additional paperwork or phone calls.

Another embodiment of the present invention may comprise an ability to compare several products at once. For example, if supplier company A was selling a more effective granular product and wanted to advertise the product to users, they may choose to include in the tool other products in the same category. All related products may be compared to show savings between the three or more types of product simultaneously. Comparisons may be made between any number of products, preferably products with a quantifiable difference in savings, costs or usage. Another aspect of the present invention may be a graph option or other visual display ability to present a graphical interpretation of savings over time or as the quantity needed increases. Some examples of graphical interpretations may include a pie chart, a bar chart or a line graph.

One aspect of the present invention provides simulation of the costs associated with marketing a product while providing potential customers the freedom to examine and manipulate a number of processing variables in estimating costs and savings. The present invention may be used in a number of scenarios including situations in which two products with a quantifiable difference are compared for cost effectiveness. Another aspect of the present invention allows the cost and savings estimator to be distributed through a computer-readable medium. Because computer-readable mediums such as CD-ROM have become relatively cheap and easily distributable, marketing costs may be kept to a minimum by eliminating travel costs and expensive presentation expenditures. Yet another aspect of the invention enables potential customers to manipulate various factors and statistics to match their company needs and profile. Thus, potential customers may calculate and examine various factors, costs and savings tailored specifically for their company or business.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or any combination thereof. In one embodiment, the aspects may be implemented via Application Specific Integrated Circuits (ASICs). Those, however, skilled in the art will recognize that the embodiments disclosed herein, in whole or in part, can be equivalently implemented in standard Integrated Circuits, as a computer program running on a computer, as a program running on a processor, as firmware, or as virtually any combination thereof and that designing the circuitry and/or writing the code for the software or firmware would be well within the skill of one of ordinary skill in the art in light of this disclosure.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

What is claimed is:

1. A computer system, comprising:
a processor; and
a memory for storing computer readable instructions that, when executed by said processor, cause the computer to perform the steps of:
receiving a set of data corresponding to a set of predetermined variables;
determining a total cost estimate of one or more products using the set of data corresponding to the set of predetermined variables;
determining a difference in cost, and generating a cost differential report according to the estimated total cost for each product; and
displaying the report.

2. The computer system of claim 1, wherein the step of receiving a set of data corresponding to a set of predetermined variables further comprises:
receiving the set of data from the user through portions of a user interface configurable for user input.

3. The computer system of claim 1, wherein the step of determining a total cost estimate of one or more products using the set of data corresponding to the set of predetermined variables further comprises: determining a total material cost for one or more products.

4. The computer system of claim 1, wherein the step of determining a total cost estimate of one or more products using the set of data corresponding to the set of predetermined variables further comprises: determining a total hidden cost value for one or more products.

5. The computer system of claim 1, wherein the step of determining a difference in cost and generating a cost differential report according to the estimated total cost for each product further comprises: determining the percentage cost differential between each pair of products.

6. The computer system of claim 1, wherein the step of determining a difference in cost and generating a cost differential report according to the estimated total cost for each product further comprises: determining the difference in total cost between each pair of products.

7. The computer system of claim 1, wherein the step of displaying the report further comprises: generating a graphical representation of costs and savings for each product.

8. The computer-system of claim 1, wherein the step of displaying the report further comprises: generating a textual or numerical summary or report detailing cost differentials for each product.

9. The computer system of claim 1, wherein the step of displaying the report further comprises: prompting the user with an option to purchase the product.

10. The computer system of claim 1, wherein the step of displaying report further comprises: displaying sales contact information.

11. A computer-readable medium having computer-executable instructions for performing a method of calculating and comparing costs and savings for one or more products, the method comprising:
receiving a set of data corresponding to a set of predetermined variables;
determining a total cost estimate of one or more products using the set of data corresponding to the set of predetermined variables;
determining a difference in cost and generating a cost differential report according to the estimated total cost for each product; and
displaying a cost and savings calculations on a graphical display.

12. The computer-readable medium according to claim 11, wherein the computer-executable instructions for performing the step of receiving from a user a set of data corresponding to a set of predetermined variables further comprises:
receiving the set of data from the user through portions of the user interface configured to receive user input.

13. The computer-readable medium according to claim 11, wherein the computer-executable instructions for performing the step of determining a total cost estimate of one or more products using the set of data corresponding to the set of predetermined variables further comprises: determining a total material cost for one or more products.

14. The computer-readable medium according to claim 11, wherein the computer-executable instructions for performing the step of determining a total cost estimate of one or more products using the set of data corresponding to the set of predetermined variables further comprises: determining a total hidden cost value for one or more products.

15. The computer-readable medium according to claim 11, wherein the computer-executable instructions for performing the step of determining a difference in cost and generating a cost differential report according to the estimated total cost for each product further comprises: determining the percentage difference between the costs of each pair of products.

16. The computer-readable medium according to claim 11, wherein the computer-executable instructions for performing the step of determining a difference in cost and generating a cost differential report according to the estimated total cost for each product further comprises: determining the difference in total cost between each pair of products.

17. The computer-readable medium according to claim 11, wherein the computer-executable instructions for performing the step of displaying the cost and savings calculations further comprises: generating a graphical representation of costs and savings for each product.

18. The computer-readable medium according to claim 11, wherein the computer-executable instructions for performing the step of displaying the cost and savings calculations further comprises: generating a textual or numerical summary or report detailing all costs and savings for each product.

19. The computer-readable medium according to claim 11, wherein the computer-executable instructions for performing the step of displaying the cost and savings calculations further comprises: prompting the user with an option to purchase the product.

20. The computer-readable medium according to claim 11, wherein the computer-executable instructions for performing the step of displaying the cost and savings calculations further comprises: displaying sales contact information.

21. A graphical user interface for a computer system, comprising:
a first display portion configured to accept user input relating to a bulk material product and a corresponding monetary value;
a second display portion configured to accept user input relating to other cost data associated with the material product; and
a third display portion configured to display graphical objects associated with generating a cost differential report associated with the material product and another predetermined bulk product.
